(19) United States
(12) Patent Application Publication
(10) Pub. No.: US 2015/0009289 A1
(43) Pub. Date: Jan. 8, 2015

(54) METHOD AND APPARATUS FOR PROVIDING THREE-DIMENSIONAL (3D) VIDEO

(71) Applicant: Electronics and Telecommunications Research Institute, Daejeon (KR)

(72) Inventors: Jin Young LEE, Seoul (KR); Kug Jin YUN, Daejeon (KR); Won-Sik CHEONG, Daejeon (KR); Gwang Soon LEE, Daejeon (KR); Namho HUR, Daejeon (KR)

(21) Appl. No.: 14/326,262

(22) Filed: Jul. 8, 2014

Related U.S. Application Data
(60) Provisional application No. 61/843,633, filed on Jul. 8, 2013.
(60) Provisional application No. 61/844,676, filed on Jul. 10, 2013.

(30) Foreign Application Priority Data
May 14, 2014 (KR) 10-2014-0057614

(51) Int. Cl. H04N 13/00

(52) U.S. Cl. CPC H04N 13/0059; H04N 13/0048
USPC 348/43

(57) ABSTRACT

A method and apparatus for providing a three-dimensional (3D) video are provided. In the method and apparatus, a base view video of the 3D video may be transmitted to a receiver via a first network that is a terrestrial network, an additional view video of the 3D video may be transmitted to the receiver via a second network, and the 3D video may be provided based on the base view video and the additional view video.

### CROSS-REFERENCE TO RELATED APPLICATIONS

This application claims the benefit under 35 U.S.C. §119(a) of U.S. Provisional Application No. 61/843,633, filed on Jul. 8, 2013, and U.S. Provisional Application No. 61/844,676, filed on Jul. 10, 2013, in the United States Patent and Trademark Office, and Korean Patent Application No. 10-2014-0057614, filed on May 14, 2014, in the Korean Intellectual Property Office, the entire disclosures of which are incorporated herein by reference for all purposes.

### BACKGROUND

1. Field of the Invention

The present invention relates to a technology of providing a three-dimensional (3D) video, and more particularly, a method and apparatus for providing 3D video using a broadcast network.

2. Description of the Related Art

Human may be aware of a distance from an object through a binocular parallax. A three-dimensional (3D) video may provide a stereoscopic effect to both eyes of a viewer based on a principle of recognizing a cubic effect by a sense of sight.

A 3D video may be provided based on a plurality of two-dimensional (2D) video. For example, a 2D video corresponding to a left eye of a viewer, and a 2D video corresponding to a right eye of the viewer may be used to generate a 3D video.

An existing broadcasting environment may be suitable for transmission of 2D video. In the existing broadcasting environment, 2D video may correspond to base view videos of a 3D video. When an additional view video is provided together with a base view video, a 3D video may be provided to a viewer.

To transmit an additional view video in the existing broadcasting environment, an additional bandwidth may be required.

### SUMMARY

An aspect of the present invention provides a method and apparatus for providing a three-dimensional (3D) video.

Another aspect of the present invention provides a method and apparatus for providing a 3D video through heterogeneous networks.

According to an aspect of the present invention, there is provided a broadcasting apparatus for providing a 3D video through heterogeneous networks, the broadcasting apparatus including: a first processing unit to encode a base view video of the 3D video, and to multiplex the encoded base view video to a Transport Stream (TS); a first transmitter to transmit the multiplexed base view video to a receiver via a first network; a second processing unit to encode an additional view video of the 3D video; and a second transmitter to transmit the encoded additional view video to the receiver via a second network, wherein the first network is a terrestrial network, and the 3D video is provided based on the base view video and the additional view video.

The first network may be an Advanced Television System Committee (ATSC) terrestrial network.

The second network may be a broadband network.

The base view video and the additional view video may be transmitted in real time to the receiver, so that the 3D video may be provided as a real-time broadcast.

The second transmitter may transmit whole data of the additional view video to the receiver, before data of the base view video is transmitted to the receiver.

The 3D video may be provided in non-real time.

The second transmitter may transmit partial data of the additional view video to the receiver, before data of the base view video is transmitted to the receiver. When the base view video is transmitted to the receiver, remaining data of the additional view video may be transmitted to the receiver.

The 3D video may be provided in non-real time.

The multiplexed base view video may include a first Presentation Time Stamp (PTS) indicating a playback time of the base view video.

The encoded additional view video may include a second PTS indicating a playback time of the additional view video.

The first PTS and the second PTS may be used to synchronize the base view video and the additional view video.

The first processing unit may multiplex the encoded base view video to the TS based on the encoded base view video and metadata associated with the 3D video.

The metadata may include pairing information used to synchronize the base view video and the additional view video.

The pairing information may include a Uniform Resource Identifier (URI) used to provide the additional view video.

The additional view video may be transmitted to the receiver through the URI.

The second processing unit may convert a format of the encoded additional view video to a Moving Picture Experts Group (MPEG)-2 format or an MPEG-4 format.

The second transmitter may transmit the additional view video with the converted format to the receiver.

According to another aspect of the present invention, there is provided a broadcasting apparatus for providing a 3D video, the broadcasting apparatus including: a first processing unit to encode a base view video of the 3D video, and to multiplex the encoded base view video to a TS; a first transmitter to transmit the multiplexed base view video to a receiver via a first network in real time; a second processing unit to encode an additional view video of the 3D video, and to multiplex the encoded additional view video; and a second transmitter to transmit the multiplexed additional view video to the receiver via a second network in non-real time, wherein the first network is a terrestrial network, and the 3D video is provided based on the base view video and the additional view video.

The first network may be an ATSC terrestrial network.

The second network may be an Advanced Television System Committee Non Real Time (ATSC NRT) network.

The multiplexed base view video may include a first PTS indicating a playback time of the base view video.

The multiplexed additional view video may include a second PTS indicating a playback time of the additional view video.

The first PTS and the second PTS may be used to synchronize the base view video and the additional view video.

Playback information of the 3D video may be provided based on the first PTS.

The first processing unit may multiplex the encoded base view video to the TS based on the encoded base view video and metadata associated with the 3D video.

The second processing unit may convert a format of the encoded additional view video to an MPEG-2 format or an MPEG-4 format.

The second processing unit may multiplex the additional view video with the converted format.

The second processing unit may signal the additional view video to transmit the multiplexed additional view video to the receiver.

During the signaling, a Service Signaling Channel (SSC) may be used to transmit a Service Map Table (SMT) and a Non-Real-Time Information Table (NRT-IT).

The SMT may provide information on a service of providing the 3D video, and the NRT-IT may provide content item information to form the service.

According to another aspect of the present invention, there is provided a method of providing a 3D video through heterogeneous networks, the method including: encoding a base view video of the 3D video; multiplexing the encoded base view video to a TS; transmitting the multiplexed base view video to a receiver via a first network; encoding an additional view video of the 3D video; and transmitting the encoded additional view video to the receiver via a second network, wherein the first network is a terrestrial network, and the 3D video is provided based on the base view video and the additional view video.

According to another aspect of the present invention, there is provided a method of providing a 3D video, the method including: encoding a base view video of the 3D video; multiplexing the encoded base view video to a TS; transmitting the multiplexed base view video to a receiver via a first network in real time; encoding an additional view video of the 3D video; multiplexing the encoded additional view video; and transmitting the multiplexed additional view video to the receiver via a second network in non-real time, wherein the first network is a terrestrial network, and the 3D video is provided based on the multiplexed base view video and the multiplexed additional view video.

### Effect

According to embodiments of the present invention, it is possible to provide a broadcast service with compatibility between a two-dimensional (2D) video and a three-dimensional (3D) video.

Additionally, according to embodiments of the present invention, it is possible to provide a 3D video through heterogeneous networks.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of providing a three-dimensional (3D) video according to an embodiment;

FIG. 2 illustrates a first scenario to provide a 3D video according to an embodiment;

FIG. 3 illustrates a second scenario to provide a 3D video according to an embodiment;

FIG. 4 illustrates a third scenario to provide a 3D video according to an embodiment;

FIG. 5 illustrates a fourth scenario to provide a 3D video according to an embodiment;

FIG. 6 is a diagram illustrating a configuration of a broadcast apparatus according to an embodiment;

FIG. 7 is a flowchart illustrating a method of providing a 3D video according to an embodiment;

FIG. 8 is a flowchart illustrating an operation of transmitting a base view video to a receiver in the method of FIG. 7;

FIG. 9 illustrates a system for providing a 3D video according to an embodiment;

FIGS. 10A through 10D are flowcharts illustrating a method by which a receiver outputs a 3D video when an additional view video is received through a Dynamic Adaptive Streaming over HyperText Transfer Protocol (HTTP) (DASH);

FIGS. 11A through 11D are flowcharts illustrating a method by which a receiver outputs a 3D video when an additional view video is received through download;

FIG. 12 is a flowchart illustrating another method of providing a 3D video according to an embodiment;

FIG. 13 illustrates another system for providing a 3D video according to an embodiment; and

FIGS. 14A through 14D are flowcharts illustrating a method by which a receiver outputs a 3D video when an additional view video is received through an Advanced Television System Committee Non Real Time (ATSC NRT) network.

### DETAILED DESCRIPTION

Hereinafter, embodiments of the present invention will be further described with reference to the accompanying drawings. In the present disclosure, like reference numerals refer to the like elements throughout.

Various changes may be applied to embodiments that will be described. It is understood, however, that there is no intention to limit the present invention to particular embodiments, forms or examples which are disclosed herein. To the contrary, the intention is to cover all modifications, equivalent structures and methods, and alternative constructions falling within the spirit and scope of the invention.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, numerals, steps, operations, elements, components and/or groups thereof, but do not preclude the presence or addition of one or more other features, numerals, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Additionally, in description of embodiments with reference to the accompanying drawings, the same reference numerals will be assigned to the same elements, regardless of drawing reference numerals. Also, descriptions of functions and constructions that are well known to one of ordinary skill in the art may be omitted for increased clarity and conciseness.

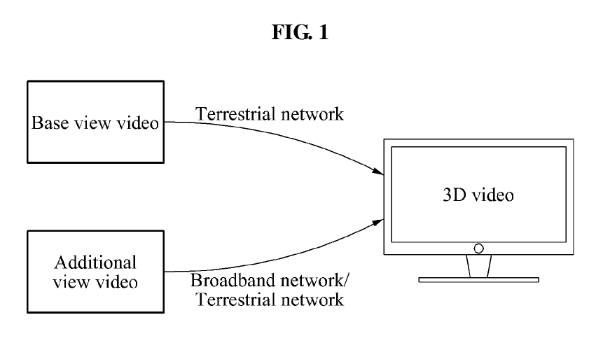

FIG. 1 is a diagram illustrating an example of providing a three-dimensional (3D) video according to an embodiment.

A broadcast service of providing a 3D video may require a wide bandwidth to provide a 3D video, compared to a broadcast service of providing a two-dimensional (2D) video. A broadcast service in which a 2D video and a 3D video are compatible with each other may require a bandwidth greater than at least two times the broadcast service of providing a 2D video.

In a compatible broadcast service, at least one of a plurality of compressed videos in a 3D video may correspond to an existing 2D video having the same resolution as a production resolution. For example, the 3D video may include a base view video and an additional view video.

To provide a 3D video without requiring an additional bandwidth in a broadcast system for providing existing 2D video, a broadband network, and an Advanced Television System Committee Non Real Time (ATSC NRT) network may be used.

A scheme of providing a 3D video using a broadband network may be referred to as a “Service Compatible Hybrid Coded 3D using BroadBand (SCHCBB).”

A scheme of providing a 3D image using an ATSC NRT network may be referred to as a “Service Compatible Hybrid Coded 3D using ATSC NRT (SCHCNRT).

A 3D video may be provided based on a base view video and an additional view video. The base view video may be, for example, an existing 2D video. The additional view video may be, for example, an image added to the base view video to provide the 3D video. For example, a viewpoint of the additional view video may be different from a viewpoint of the base view video.

The base view video of the 3D video may be transmitted to a receiver via a first network. The first network may be, for example, a terrestrial network. The terrestrial network may be, for example, a broadcast network, or an ATSC terrestrial network.

The additional view video of the 3D video may be transmitted to the receiver via a second network.

The second network may be, for example, a broadband network. The broadband network may be a network via the Internet, that is, may be a data communication network, not a broadcast network.

Additionally, the second network may be, for example, a terrestrial network. The terrestrial network may be, for example, an ATSC NRT network.

When a base view video is transmitted to the receiver via the ATSC terrestrial network, and an additional view video is transmitted to the receiver via the broadband network or the ATSC NRT network, an additional bandwidth used to transmit the additional view video may not be required in a system of transmitting the base view video.

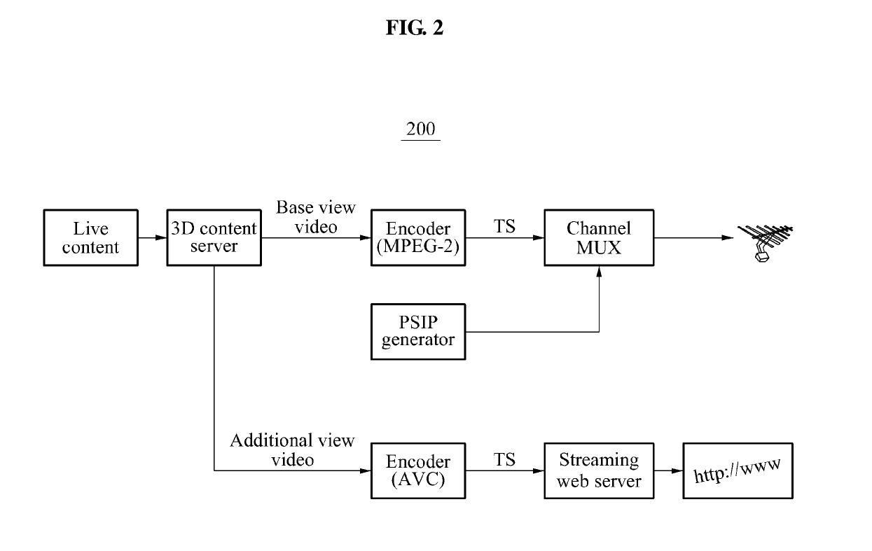

Hereinafter, a service scenario to provide a 3D video will be further described with reference to FIGS. 2 through 5.

To describe embodiments, the following reference documents may be used:
Reference [1]: IEEE/ASTM: “Use of the International Systems of Units (SI): The Modern Metric System,” Doc. SI 10-2002, Institute of Electrical and Electronics Engineers, New York, N.Y;
Reference [2]: ATSC: “ATSC Digital Television Standard, Part 3—Service Multiplex and Transport Subsystem Characteristics,” Doc. A/53, Part 3:201x, Advanced Television Systems Committee, Washington, D.C., [TBD];
Reference [3]: ATSC: “ATSC Digital Television Standard, Part 4—MPEG-2 Video System Characteristics,” Doc. A/53, Part 4:201x, Advanced Television Systems Committee, Washington, D.C., [TBD];
Reference [4]: ATSC: “Use of AVC in the ATSC Digital Television System, Part 1—Video System Characteristics,” Doc. A/72, Part 1, Advanced Television Systems Committee, Washington, D.C., 29 Jul. 2008;
Reference [5]: ATSC: “Program and System Information Protocol for Terrestrial Broadcast and Cable,” Doc. A/65:2009, Advanced Television Systems Committee, Washington, D.C., 3 Aug. 2009;
Reference [6]: ATSC: “ATSC Parameterized Services Standard,” Doc. A/71, Advanced Television Systems Committee, Washington, D.C., 26 Mar. 2007;
Reference [7]: ITU-T Recommendation H.262|ISO/IEC 13818-2: “Information technology—Generic coding of moving pictures and associated audio information: Video”;
Reference [8]: ITU-T Recommendation H.264|ISO/IEC 14496-10:2010: “Information technology—Coding of audio-visual objects—Part 10: Advanced Video Coding”;
Reference [9]: ITU-T Recommendation H.222.0 (2012)|ISO/IEC 13818-1:2012, “Information technology—Generic coding of moving pictures and associated audio information: Systems”;
Reference [10]: CEA: CEA-708.1, “Digital Television Closed Captioning: 3D Extensions,” Consumer Electronics Association, Arlington, Va., 2012;
Reference [11]: ATSC: “Use of AVC in the ATSC Digital Television System, Part 2—Transport Subsystem Characteristics,” Doc. A/72, Part 2, Advanced Television Systems Committee, Washington, D.C., 29 Jul. 2008;
Reference [12]: ATSC: “Non-Real-Time Content Delivery,” Doc. A/103, Advanced Television Systems Committee, Washington, D.C., 9 May 2012;
Reference [13]: ISO/IEC 14496-14:2003: “Information technology—Coding of audio-visual objects—Part 14: MP4 file format”;
Reference [14]: ISO/IEC 14496-12:2008: “Information technology—Coding of audio-visual objects—Part 12: ISO base media file format”;
Reference [15]: ATSC: “3D-TV Terrestrial Broadcasting, Part 2—Service Compatible Hybrid Coding Using Real-Time Delivery” Doc. A/104, Advanced Television Systems Committee, Washington, D.C., 26 Dec. 2012; and
Reference [16]: ATSC: “Non-Real-Time Content Delivery” Doc. A/103:2012, Advanced Television Systems Committee, Washington, D.C., 9 May 2012.

FIG. 2 illustrates a first scenario 200 to provide a 3D video according to an embodiment.

The first scenario 200 may be a service scenario to provide live content.

The live content may be stored in a 3D content server. The 3D content server may provide a 3D video to a receiver using a terrestrial network and a broadband network.

The first scenario 200 may be called “SCHCBB streaming scheme.”

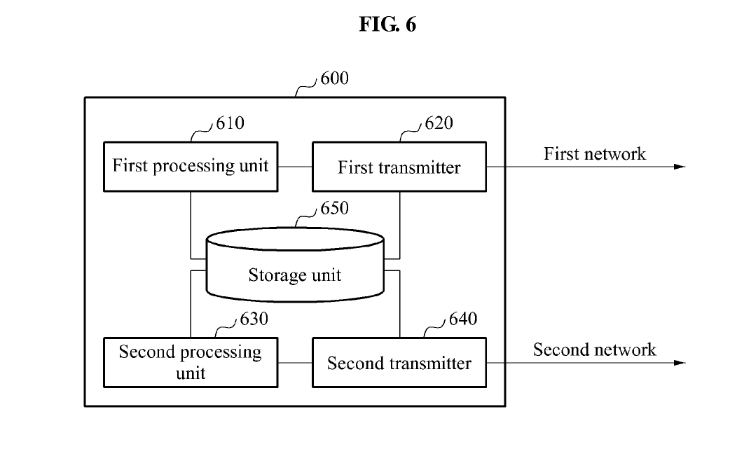

A method of providing a 3D video that is live content will be further described with reference to FIGS. 6 through 10.

The description of FIG. 1 is also applicable to one or more alternate and/or additional embodiments, and accordingly will not be repeated here.

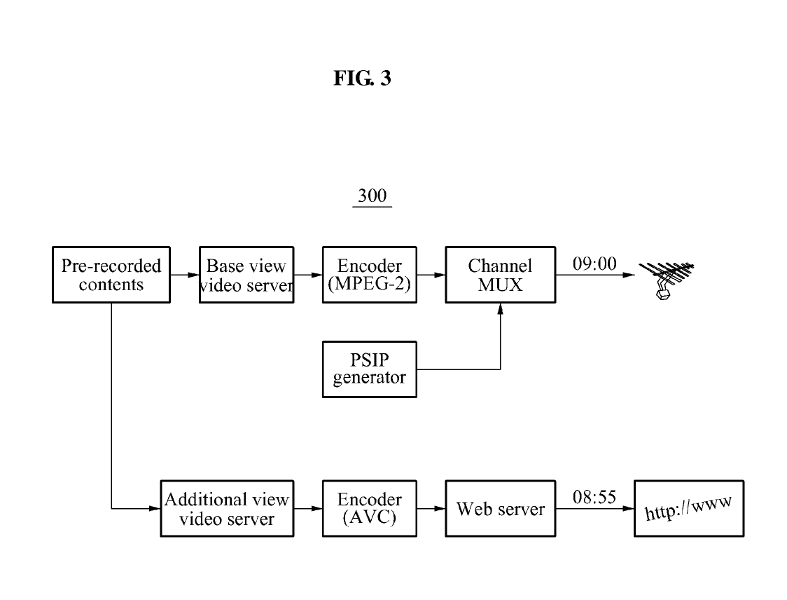

FIG. 3 illustrates a second scenario 300 to provide a 3D video according to an embodiment.

The second scenario 300 may be a service scenario to provide pre-recorded contents.

A base view video and an additional view video may be stored in a base view video server and an additional view video server, respectively.

In the second scenario 300, before a base view video is transmitted to a receiver, an additional view video may be transmitted in advance to the receiver. The additional view video may be transmitted via a broadband network to the receiver. The second scenario 300 may be called “SCHCBB download scheme.”

For example, when a base view video is scheduled to be transmitted to a receiver at 09:00, an additional view video may be transmitted at 08:55. Before data of the base view video is transmitted to the receiver, partial data of the additional view video may be transmitted to the receiver.

In the second scenario 300, when the base view video is transmitted to the receiver, remaining data of the additional view video may be transmitted to the receiver. For example, when a base view video is transmitted to the receiver, an additional view video output later than the transmitted base view video may be transmitted to the receiver.

A method of providing a 3D video by transmitting partial data of an additional view over a broadband network to a receiver, before data of a base view video is transmitted to the receiver will be further described with reference to FIGS. 6 through 9 and 11.

The description of FIGS. 1 and 2 is also applicable to one or more alternate and/or additional embodiments, and accordingly will not be repeated here.

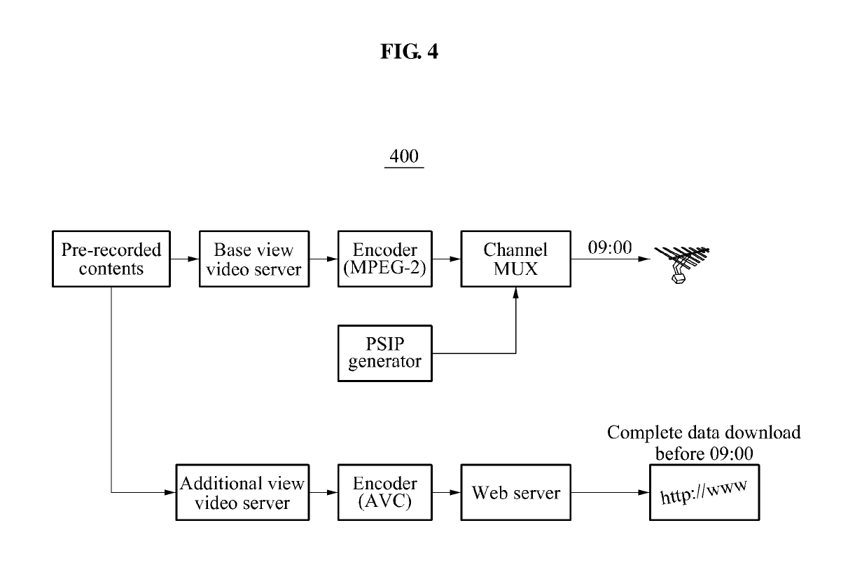

FIG. 4 illustrates a third scenario 400 to provide a 3D video according to an embodiment.

The third scenario 400 may be a service scenario to provide pre-recorded contents.

A base view video and an additional view video may be stored in a base view video server and an additional view video server, respectively.

In third scenario 400, before a base view video is transmitted to a receiver, an additional view video may be transmitted in advance to the receiver. The additional view video may be transmitted via a broadband network to the receiver. The third scenario 400 may be included in an SCHCBB download scheme.

For example, when a base view video is scheduled to be transmitted to a receiver at 09:00, whole data of an additional view video may be transmitted to the receiver before 09:00.

A method of providing a 3D video by transmitting whole data of an additional view over a broadband network to a receiver, before data of a base view video is transmitted to the receiver will be further described with reference to FIGS. 6 through 9 and 11.

The description of FIGS. 1 through 3 is also applicable to one or more alternate and/or additional embodiments, and accordingly will not be repeated here.

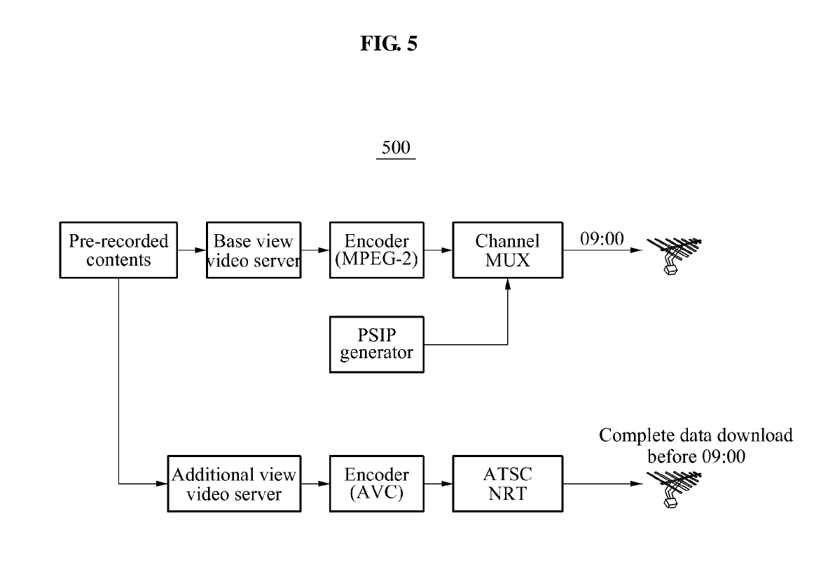

FIG. 5 illustrates a fourth scenario 500 to provide a 3D video according to an embodiment.

The fourth scenario 500 may be a service scenario to provide pre-recorded contents.

A base view video and an additional view video may be stored in a base view video server and an additional view video server, respectively.

In the fourth scenario 500, before a base view video is transmitted to a receiver, an additional view video may be transmitted in advance to the receiver. The additional view video may be transmitted via a terrestrial network to the receiver. The fourth scenario 500 may be an SCHCNRT scheme.

For example, when a base view video is scheduled to be transmitted to a receiver at 09:00, whole data of an additional view video may be transmitted to the receiver before 09:00.

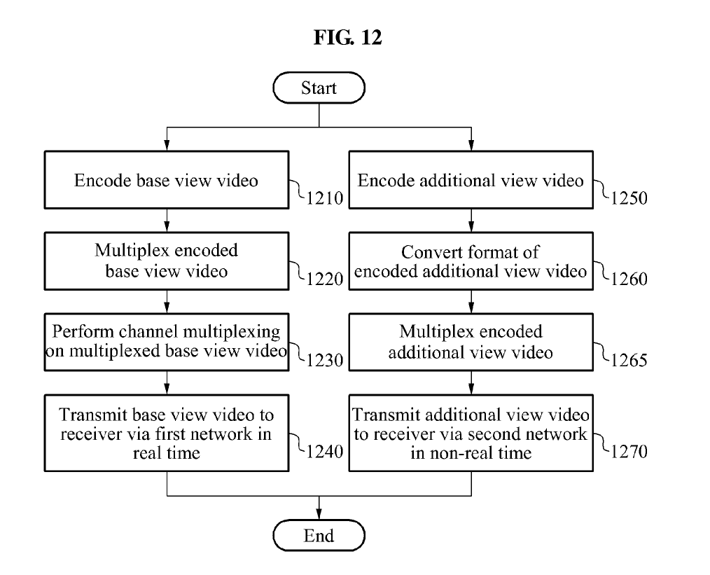

A method of providing a 3D video by transmitting whole data of an additional view over a terrestrial network to a receiver, before data of a base view video is transmitted to the receiver will be further described with reference to FIGS. 12 through 14D.

The description of FIGS. 1 through 4 is also applicable to one or more alternate and/or additional embodiments, and accordingly will not be repeated here.

FIG. 6 illustrates a configuration of a broadcast apparatus 600 according to an embodiment.

The broadcast apparatus 600 of FIG. 6 may include a first processing unit 610, a first transmitter 620, a second processing unit 630, a second transmitter 640, and a storage unit 650.

The broadcast apparatus 600 may perform the first scenario 200, the second scenario 300, and the third scenario 400 that are described above.

The broadcast apparatus 600 may provide a 3D video to a receiver via heterogeneous networks. The heterogeneous networks may refer to a plurality of different networks, for example, a terrestrial network, and a broadband network.

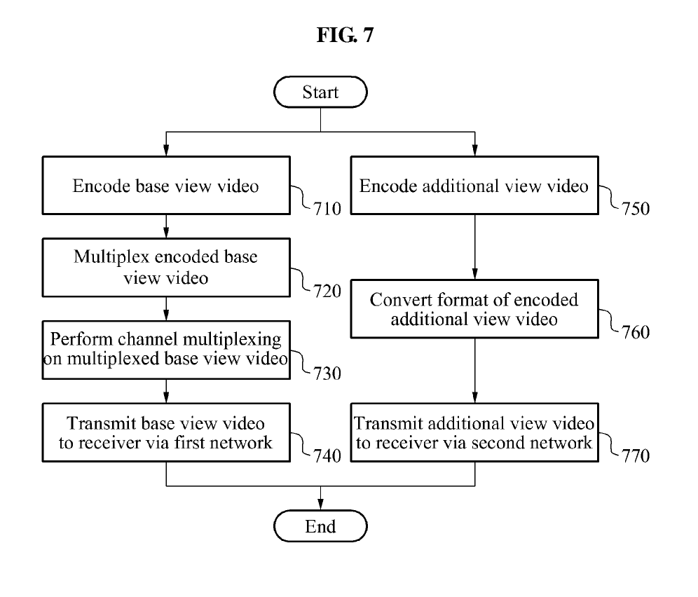

The first processing unit 610, the first transmitter 620, the second processing unit 630, the second transmitter 640, and the storage unit 650 will be further described with reference to FIGS. 7 through 11.

The description of FIGS. 1 through 5 is also applicable to one or more alternate and/or additional embodiments, and accordingly will not be repeated here.

FIG. 7 is a flowchart illustrating a method of providing a 3D video according to an embodiment.

Referring to FIG. 7, in operation 710, the first processing unit 610 may encode a base view video of a 3D video. Encoding of the base view video may be, for example, compression of the base view video. The storage unit 650 may store the base view video. The storage unit 650 may be, for example, the 3D content server of FIG. 2, the base view video server of FIG. 3, or the base view video server of FIG. 4.

The first processing unit 610 may encode the base view video, using an encoder. The encoder may include, for example, a Moving Picture Experts Group (MPEG)-2 encoder. The first processing unit 610 may encode the base view video, in compliance with MPEG-2 video Main Profile @ High Level or Main Profile @ Main Level in reference [7]. The first processing unit 610 may encode the base view video, in compliance with ATSC A/53 Part 4 and ATSC A/72 Part 1.

The base view video may be encoded in one of formats listed in Table 1 below.

TABLE 11

| | | Display aspect | | |
|---|---|---|---|---|
| Vertical | Horizontal | ratio/Sample aspect | | Progressive/ |
| size | size | ratio | Frame rate | Interlaced |
| 1080 | 1920 | 16:9/square sample | 23.976, 24, 29.97, | P |
| | | | 30 | |
| 1080 | 1920 | 16:9/square sample | 29.97, 30 | I |
| 720 | 1280 | 16:9/square sample | 23.976, 24, 29.97, | P |
| | | | 30, 59.94, 60 | |

In an embodiment, the first processing unit 610 may encode a base view video based on ancillary data. The ancillary data may be, for example, closed captioning data. The closed captioning data may be included in the base view video, in compliance with ATSC A/53 Part 4 of reference [3]. A closed captioning command (for example, disparity information) to support a z-axis of a caption window may comply with CEA-708.1 of reference [10], and may be carried in cc_data( ) specified in section 6.2.3.1 of ATSC A/53 Part 4 of reference [3].

A format of the encoded base view video may correspond to an Elementary Stream (ES).

In operation 720, the first processing unit 610 may multiplex the encoded base view video. The first processing unit 610 may multiplex the encoded base view video based on an encoded audio.

For example, the first processing unit 610 may multiplex the encoded base view video to a Transport Stream (TS).

The first processing unit 610 may multiplex the encoded base view video using a multiplexer (MUX). Multiplexing may be, for example, program multiplexing.

Multiplexing of the base view video may comply with ATSC A/53 Part 3 of reference [2].

For example, the first processing unit 610 may multiplex the encoded base view video to a TS, based on the encoded base view video and metadata. The metadata may include information used to generate a 3D video.

The metadata may include Program Specific Information (PSI).

The PSI may include at least one of a Program Association Table (PAT) used to maintain a program information list in a channel, a Conditional Access Table (CAT) including access control information, for example scrambling, a Program Map Table (PMT) including information on audio streams and video streams in a program, and a Network Information Table (NIT) including information on a network used to transmit MPEG information.

The PMT may provide information associated with each program existing in program_number and a TS. The PMT may list ESs making up an MPEG-2 program. The PMT may provide location information for both a selective descriptor for each ES and a selective descriptor that describes a complete MPEG-2 stream. Each ES may be identified by a stream_type value.

In an example, the base view video may be signaled using a stream_type value of “0x02.” In another example, video frame synchronization metadata of SCHCBB that will be described below may be signaled using a stream_type value of “0x06.”

For signaling of a program provided using the SCHCBB (hereinafter, referred to as a “SCHCBB program”), stereoscopic_program_info_descriptor( ) and stereoscopic_video_info_descriptor( ) specified in reference [9] may be used. In the following description, a programming code or a field of a code may be denoted by a form of a_b_c( ) or a_b_c.

The stereoscopic_program_info_descriptor( ) specified in reference [9] may be located in a loop following a program_info_length field of a PMT to notify existence of the SCHCBB program. For the SCHCBB, stereoscopic_service_type may be set to “011.”

The stereoscopic_service_type may be described with reference to Table 2 below.

TABLE 2

| Value | Description |
|---|---|
| 000 | Unspecified |
| 001 | 2D (monoscopic) service |
| 010 | Frame-compatible stereoscopic 3D service |
| 011 | Service-compatible stereoscopic 3D service |
| 100-111 | Rec. ITU-T H.222.0-ISO/IEC 13818-1 reserved |

The stereoscopic_service_type may be set to “001” to indicate that a base view video stream and an additional view video stream of the SCHCBB program are carrying the same video, for example, the same program or content.

The stereoscopic_video_info_descriptor( ) specified in reference [9] may be located in a loop following an ES_info_length field in the PMT to identify a view component of the SCHCBB program, that is, a base view video stream and an additional view video stream.

Values of horizontal_upsampling_factor and vertical_upsampling_factor may be used to signal an up-sampling factor of the additional view video.

The base view video may include a first Presentation Time Stamp (PTS) indicating a playback time of the base view video. Playback information on a 3D video may be provided based on the first PTS.

The additional view video may include a second PTS indicating a playback time of the additional view video. The first PTS and the second PTS may be used to synchronize the base view video and the additional view video.

When the first PTS and the second PTS differ from each other, data used to pair frames of the base view video and frames of the additional view video may be required. The frames of the base view video and frames of the additional view video may be paired with each other and accordingly, a 3D video may be synchronized.

Metadata may include pairing information to synchronize the base view video and the additional view video. For example, the metadata may carry, in media_pairing_information( ), data used to pair frames of the base view video and frames of the additional view video. The media_pairing_information( ) may be carried by a Packetized Elementary Stream (PES) packet, to be multiplexed with the base view video.

When the additional view video is streaming-transmitted, the media_pairing_information( ) may be multiplexed with the base view video.

The PES packet may be described with reference to Table 3 below.

TABLE 3

| | |
|---|---|
| stream_id | 0xBD |
| data_alignment_indicator | ‘1’ |
| | Note: ‘1’ indicating start of media paring |
| | information needs to be aligned with start |
| | of a PES payload. |
| PES_packet_data_byte | Contiguous bytes of data from an ES |
| | indicated by stream_id or a Program |
| | Identifier (PID) of a packet |

PES_data_field( ) for PES_packet_data_byte may be further described in Table 4 below.

TABLE 4

| Syntax | Number of bits | Format |
|---|---|---|
| PES_data_field( ){ | 8 | uimsbf |
| data_identifier | var | |
| media_pairing_information( ) | | |
| } | | |

uimsbf may indicate unsigned integer, most significant bit first. In other words, uimsbf may indicate a most significant bit (MSB) of an unsigned integer.

A data_identifier field of Table 4 may be used to identify a private stream PES for the SCHCBB. For example, the data_identifier field may have a value of “0x33.”

A media_pairing_information( ) field of Table 4 may provide media pairing information to be used for synchronization between the base view video and the additional view video.

Syntax of the media_pairing_information( ) field may be described with reference to Table 5.

TABLE 5

| | Number | |
|---|---|---|
| Syntax | of bits | Format |
| media_pairing_information( ) { | | |
| referenced_media_filename_length | 8 | uimsbf |
| for(i=0;i<referenced_media_filename_length;i++){ | | uimsbf |
| referenced_media_filename_byte | 8 | uimsbf |
| } | | |
| reserved | 7 | |
| frame_number | 25 | |
| } | | |

A referenced_media_filename_length field of Table 5 may provide a length of a referenced_media_filename_byte field of Table 5 in bytes.

The referenced_media_filename_byte field may provide a Uniform Resource Identifier (URI) of referenced media. The referenced media may be, for example, an additional view video, an additional view video stream or an additional view video file. The pairing information may include a URI to provide an additional view video.

The receiver may identify the URI to provide the additional view video and accordingly, the additional view video may be transmitted to the receiver through the URI.

A frame_number field of Table 5 may indicate a frame number of streams of SCHCBB. The frame number may start with “0” at a beginning time of the SCHCBB, and may be monotonically incremented.

Metadata may include referenced media information.

The referenced media information may be carried in referenced_media_information( ). The referenced_media_information( ) may provide access information, synchronization information, and playback information of an additional view video associated with a base view video. The referenced_media_information( ) may be provided with a stream_type value of “0x05” specified in reference [9] for additional view video stream information.

A structure of private_section( ) including the referenced_media_information( ) may be further described in Table 6 below. Constraints of the private_section( ) may be further described in Table 7 below.

TABLE 6

| | Number | |
|---|---|---|
| Syntax | of bits | Format |
| private_section( ) { | | |
| table_id | 8 | ‘0x41’ |
| section_syntax_indicator | 1 | bslbf |
| private_indicator | 1 | bslbf |
| reserved | 2 | bslbf |
| private_section_length | 12 | uimsbf |
| if (section_syntax_indicator = = ‘0’) { | | |
| for (i = 0; i < N; i++) { | | |
| private_data_byte | 8 | bslbf |
| } | | |
| } | | |
| } | | |

bslbf may represent bit string, left bit first. In other words, bslbf may indicate a leftmost bit in a bit string.

TABLE 7

| table_id | 0x41 (user private) |
|---|---|
| section_syntax_indicator | ‘0’ |
| | referenced media information( ) follows |
| | private_section_length |
| private_indicator | ‘1’ |
| private_data_byte | follows referenced_media_information( ) |
| | in Table 8 |

TABLE 8

| | Number | |
|---|---|---|
| Syntax | of bits | Format |
| referenced_media_information( ) { | | |
| version_number | 8 | uimsbf |
| num_hybrid_service_programs | 8 | uimsbf |
| for(i=0; i< num_hybrid_service_programs ; i++){ | | |
| hybrid_delivery_protocol | 2 | uimsbf |
| additionalview_availability_indicator | 2 | bslbf |
| hybrid_service_sync_type | 2 | uimsbf |
| reserved | 2 | ‘11’ |
| num_referenced_media_files | 8 | uimsbf |
| for(i=0; i< num_referenced_media_files ; i++){ | | |
| referenced_media_play_start_time | 32 | uimsbf |
| referenced_media_expiration_time | 32 | uimsbf |
| referenced_media_filesize | 32 | uimsbf |
| referenced_media_type | 4 | uimsbf |
| referenced_media_codec_info | 4 | uimsbf |
| referenced_media_files_URI_length | 8 | uimsbf |
| for(i=0;i<referenced_media_files_URI_length;i++){ | | |
| referenced_media_ files_URI_byte | va | 8*N |
| } | r | |
| } | | |
| } | | |

A version_number field of Table 8 may provide a version number of the referenced_media_information( ). A value of the version_number field may monotonically increase based on a change in information in the referenced_media_information( ). For example, the value of the version_number field may be incremented by “1.”

A num_hybrid_service_programs field of Table 8 may indicate a number of SCHCBB services to be provided.

A hybrid_delivery_protocol field of Table 8 may provide a delivery protocol of an additional view video of an SCHCBB, as defined in Table 9 below.

TABLE 9

| Value | Description |
|---|---|
| 0x00 | Forbidden |
| 0x01 | Dynamic Adaptive Streaming over |
| | HyperText Transfer Protocol (HTTP) |
| | (DASH) |
| 0x02 | HTTP without using DASH |
| 0x03 | File Transfer Protocol (FTP) |
| 0x04~0xFF | Reserved for future use |

A type of methods of transmitting an additional view video to the receiver may be provided by hybrid_delivery_protocol. For example, an additional view video may be provided to the receiver, using a DASH, an HTTP without using a DASH, or an FTP.

A value of an additionalview_availability_indicator field of Table 8 may be further described in Table 10 below.

TABLE 10

| Value | Description |
|---|---|
| 00 | Additional view video is available for streaming at a program start |
| | time |
| 01 | Additional view video is available for download and streaming before |
| | the program start time (incomplete download) |
| 10 | Additional view video is completely downloaded before program the |
| | program start time (complete download) |
| 11 | Reserved for future use |

The additionalview_availability_indicator field may indicate availability of an additional view video. A value of “00” in the additionalview_availability_indicator field may indicate that an additional view video and a base view video are provided at the same time. For example, in a delay of a network that transmits an additional view video, a base view video may be buffered to a receiver to be synchronized with the additional view video.

A value of “01” in the additionalview_availability_indicator field may indicate that an additional view video is provided earlier than a base view video. The value of “01” may indicate that partial data of an additional view video is transmitted to a receiver before a time at which a program (for example, a 3D video) starts, but data of the additional view video is not completely downloaded before the time. Partially downloaded data of the additional view file may be buffered to the receiver to be synchronized with the base view video.

A value of “10” in the additionalview_availability_indicator field may indicate that data of the additional view video is completely downloaded to the receiver to be synchronized with the base view video before the time.

A value of a hybrid_service_sync_type field of Table 8 may be described in Table 11 below.

TABLE 11

| Value | Description |
|---|---|
| 00 | Forbidden |
| 01 | SMPTE_timecode in ES |
| 10 | media_pairing_information in PES packet |
| 11 | Reserved for future use |

The hybrid_service_sync_type field may provide information on a scheme of synchronizing a base view video and an additional view video.

The base view video and the additional view video may be synchronized at either an ES level or a PES level. For ES level synchronization, a value of “01” in the hybrid_service_sync_type field may be used. For PES level synchronization, a value of “10” in the hybrid_service_sync_type field may be used. In the PES level synchronization, the above-described media_pairing_information field may be used. In the ES level synchronization, information on SMPTE_timecode may be included in a Group Of Pictures (GOP) header of an MPEG-2 and in Picture Timing Supplemental Enhancement Information (PT SEI) of Advanced Video Coding (AVC).

The SMPTE_timecode may be further described with reference to Table 12 below.

TABLE 12

| | Range | Number | |
|---|---|---|---|
| Time_code | of values | of bits | Format |
| Drop_frame_flag | | 1 | bslbf |
| Time_code_hours | 0~23 | 5 | uimsbf |
| Time_code_minutes | 0~59 | 6 | uimsbf |
| Market_bit | 1 | 1 | bslbf |
| Time_code_seconds | 0~59 | 6 | uimsbf |
| Time_code_pictures | 0~59 | 6 | uimsbf |

For example, only “1” may be used for Drop_frame_flag in the National Television System Committee (NTSC).

A num_referenced_media_files field of Table 8 may indicate a number of referenced media files that form an additional view video. In a streaming service, the num_referenced_media_files field may be set to “1” because only a single Media Presentation Description (MPD) file needs to exist.

A referenced_media_play_start_time field of Table 8 may indicate a start time of an additional view video stream in a streaming service.

In the streaming service, a value of the referenced_media_play_start_time field may indicate an availability start time of the MPD file. The availability start time of the MPD file may be identical to a time at which a program starts.

In a download service, the value of the referenced_media_play_start_time field may indicate a start time of each of referenced media files forming an additional view video. The value of the referenced_media_play_start_time field may be provided in Universal Time Coordinated (UTC).

A referenced_media_expiration_time field of Table 8 may indicate an expiration time of each referenced media file. In the streaming service, a value of the referenced_media_expiration_time field may be identical to a time at which a program ends. The value of the referenced_media_expiration_time field may be provided in UTC.

A referenced_media_filesize field of Table 8 may indicate a size of each referenced media file in bytes. In the streaming service, a value of the referenced_media_filesize field may be set to “0.”

A referenced_media_type field of Table 8 may indicate a type of an additional view video file (for example, an MPEG-2 Advanced Audio Coding (MP4) or an International Organization for Standardization Base Media File Format (ISOBMFF)), or a type of an additional view video stream (for example, an MPEG-2 TS).

The referenced_media_type field may be further described in Table 13 below.

TABLE 13

| Value | Description |
|---|---|
| 00 | Reserved |
| 01 | MPEG-2 TS |
| 10 | ISOBMFF |
| 11 | MP4 |

A referenced_media_codec_info field of Table 8 may provide codec information of an additional view video.

The referenced_media_codec_info field may be further described in Table 14 below.

TABLE 14

| Value | Description |
|---|---|
| 00 | AVC/H.264 Main Profile @ Level 4.0 |
| 01 | AVC/H.264 High Profile @ Level 4.0 |
| 10~11 | Reserved for future use |

A referenced_media_files_URI_byte field of Table 8 may provide a URI length of referenced media or an MPD file.

In operation 730, the first processing unit 610 may perform channel multiplexing based on the multiplexed base view video and channel multiplexing information. The first processing unit 610 may generate a channel-multiplexed TS through channel multiplexing. For example, the channel multiplexing information may include Program and System Information Protocol (PSIP) data.

For example, the first processing unit 610 may perform channel multiplexing on the base view video, based on the PSIP data.

The PSIP data may include at least one of a System Time Table (STT) indicating current time information, a Master Guide Table (MGT) indicating pointers to other PSIP tables, a Virtual Channel Table (VCT) used to assign numerals to each channel, a Rating Region Table (RRT) indicating a rating of media assigned for each region, an Event Information Table (EIT) including a program title and guide data, and an Extended Text Table (ETT) including detailed information on a program and a channel.

The VCT may be, for example, a Territorial VCT (TVCT). The TVCT may include information on various channels transmitted in a physical territorial broadcast channel.

A virtual channel that provides an SCHCBB may be identified by service_type set to “0x09” in a TVCT. The following descriptors may be located in a descriptor loop following a descriptors_length field of terrestrial_virtual_channel_table_section( ) or cable_virtual_channel_table_section( ). The following descriptors may include, for example, at least one of a Service Location Descriptor (SLD) of reference [6] and a Parameterized Service Descriptor (PSD).

The PSD may be further described in Tables 15 through 17 below. The PSD may be a parameterized_service_descriptor( ) field.

To transfer specific information used by the receiver to determine whether a meaningful presentation of services on a channel is to be created, the parameterized_service_descriptor( ) may be provided in a virtual channel of a service_type value of “0x09.” The PSD may carry a payload. Syntax and semantics of the payload may be application-specific. A field called “application_tag” may identify an application to which the payload is applied.

TABLE 15

| | Number | |
|---|---|---|
| Syntax | of bits | Mnemonic |
| parameterized_service_descriptor( ) { | | |
| descriptor_tag | 8 | uimsbf |
| descriptor_length | 8 | uimsbf |
| application_tag | 8 | bslbf |
| application_data( ) | var | |
| } | | |

In a descriptor_tag field of Table 15, an 8-bit unsigned integer may have a value of “0x8D” used to identify the above descriptor as parameterized_service_descriptor( ).

In a descriptor_length field of Table 15, an 8-bit unsigned integer may specify a length (in bytes) immediately following the descriptor_length field in an end of the descriptor. A maximum value of the descriptor_length field may be “255.”

In an application_tag field of Table 15, an 8-bit unsigned integer may identify an application associated with application_data( ). Values of the application_tag may be specified in the present invention or other ATSC standards.

Syntax and semantics of an application_data( ) field of Table 15 may be specified in the ATSC standard that establishes the associated application_tag.

The parameterized_service_descriptor( ) as defined above may be used to transfer parameters specific to a particular application. For channels containing 3D content, the application_tag may have a value of “0x01.” The application_data( ) associated with the application_tag with the value of “0x01” may be further described in Table 16 below.

TABLE 16

| | Number | |
|---|---|---|
| Syntax | of bits | Format |
| application_data(0x01) { | | |
| reserved | 3 | uimsbf |
| 3D_channel_type | 5 | uimsbf |
| for (i=0; i<N; i++) { | | |
| reserved | 8 | bslbf |
| } | | |
| } | | |

In a 3D_channel_type field of Table 16, a 5-bit unsigned integer may indicate a type of 3D services carried in a virtual channel associated with the parameterized_service_descriptor( ). Coding for the 3D_channel_type may be described in Table 17 below. The SCHCBB may use a value of “0x04.” An SCHCNRT that will be described below may use a value of “0x05.”

TABLE 17

| 3D_channel_type | Description |
|---|---|
| 0x00 | Frame compatible stereoscopic 3D service—side-by-side |
| 0x01 | Frame compatible stereoscopic 3D service—top and |
| | bottom |
| 0x02 | Reserved |
| 0x03 | Full-frame stereoscopic 3D service—base view video |
| | stream and additional view video stream; additional view |
| | video in-band |
| 0x04 | Full-frame stereoscopic 3D service—broadcast and |
| | broadband hybrid |
| 0x05 | Full-frame stereoscopic 3D service—broadcast and NRT |
| 0x06-0x1F | Reserved |

Table 18 shows an example of a TVCT for the SCHCBB.

TABLE 18

```
TVCT
...
for (i<num_channels_in_section) {
  ...
  major_channel_number = 0x003
  minor_channel_number = 0x002
  ...
  program_number = 0x0002
  ...
  service_type = 0x09 (extended parameterized service)
  ...
  service_location_descriptor( )
  parameterized_service_descriptor( )
  ...
}
```

A service_location_descriptor( ) field of Table 18 may indicate a PID of an ES of an additional view video of the SCHCBB. The parameterized_service_descriptor( ) with the application_tag having the value of “0x01” may provide information on a type of 3D services transmitted to a receiver. The information may facilitate an operation of a 3DTV receiver that represents a stereoscopic 3D video.

The stereoscopic_program_info_descriptor( ) specified in reference [9] may be located in a 3D event loop in an EIT, to indicate that a future event is in 3D.

The 3D event loop in the EIT may be shown in Table 19 below.

TABLE 19

```
EIT
...
for (j < num_events_in_section) {
  event_id
  start_time
  ...
  length_in_seconds
  ...
  stereoscopic_program_info_descriptor( )
    linkage_info_descriptor( )
  ...
}
```

In Table 19, linkage_info_descriptor( ) may be located following the stereoscopic_program_info_descriptor( ) in the EIT, to provide information for referenced media files.

The linkage_info_descriptor( ) may be described with reference to Table 20 below.

TABLE 20

| | Number | |
|---|---|---|
| Syntax | of bits | Format |
| linkage_info_descriptor( ) { | | |
| descriptor_tag | 8 | uimsbf |
| descriptor_length | 8 | uimsbf |
| hybrid_delivery_protocol | 2 | uimsbf |
| additionalview_availability_indicator | 1 | bslbf |
| reserved | ‘11111’ | bslbf |
| num_referenced_media_files | 8 | uimsbf |
| for (i=0; i< num_referenced_media_files ; i++) { | | |
| referenced_media_files_URI _length | 8 | uimsbf |
| for (i=0; kreferenced_media_files_URI _length; i++) { | | |
| referenced_media_files_URI_byte | var | |
| } | | |
| } | | |
| } | | |

A descriptor_tag field of Table 20 may be an 8-bit field. The descriptor_tag field may identify each descriptor.

A descriptor_length field of Table 20 may be an 8-bit field. The descriptor_length field may specify a number of bytes of a descriptor immediately following the descriptor_length field.

A hybrid_delivery_protocol field of Table 20 may provide a type of SCHCBB defined in Table 9 that is described above.

An additionalview_availability_indicator field of Table 20 may provide availability of an additional view video defined in Table 10 that is described above.

A num_referenced_media_files field of Table 20 may provide a number of referenced media files, or a number of MPD files.

A referenced_media_files_URI_length field of Table 20 may provide a length of a URI of a referenced media file or an MPD file in bytes.

A referenced_media_files_URI_byte field of Table 20 may provide URI information of each referenced media file or an MPD file.

Signaling at 2D/3D boundaries may comply with section 4.6.3 in A/104 Part2 of reference [15].

According to an embodiment, channel multiplexing may comply with ATSC A/53 Part 3 of reference [2].

In operation 740, the first transmitter 620 may transmit the base view video to the receiver via the first network. For example, the first transmitter 620 may transmit the base view video multiplexed to the TX to the receiver via the first network.

The first network may be, for example, a terrestrial network. The terrestrial network may be, for example, an ATSC terrestrial network. The first network may comply with an ATSC A/53 scheme.

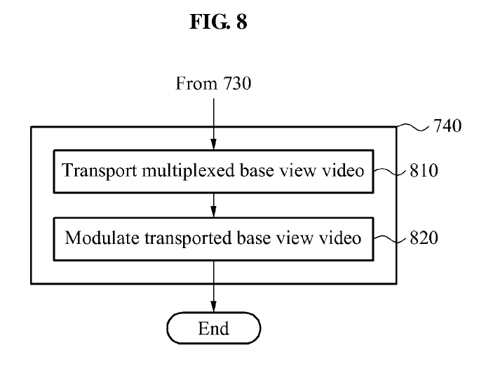

Operation 740 will be further described with reference to FIG. 8.

In operation 750, the second processing unit 630 may encode an additional view video of the 3D video. Encoding of the additional view video may be, for example, compression of the additional view video. The storage unit 650 may store the additional view video. The storage unit 650 may be, for example, the 3D content server of FIG. 2, the additional view video server of FIG. 3, or the additional view video server of FIG. 4.

For example, the second processing unit 630 may encode the additional view video, in compliance with AVC/H.264 Main Profile @ Level 4.0 or High Profile @ Level 4.0 of reference [8]. The second processing unit 630 may encode the additional view video, in compliance with ATSC A/53 Part 4 and ATSC A/72 Part 1.

The additional view video may be encoded in one of the formats listed in Table 1.

In an example, the second processing unit 630 may generate an additional view video stream for streaming, by encoding the additional view video. The additional view video stream may be a TS.

In another example, the second processing unit 630 may generate an additional view video file for download, by encoding the additional view video. The additional view video file may have one of an MP4 format, an ISOBMFF, and a format of an MPEG-2 TS.

To provide a 3D video, a base view video and an additional view video may be encoded in the same format.

The additional view video may not be multiplexed, because only a video is transmitted without an audio.

In operation 760, the second processing unit 630 may convert a format of the encoded additional view video.

The format of the additional view video may be converted to one of an MPEG-2 TS with constraints specified in ATSC A/53 and file formats of reference [13] or [14], regardless of a protocol used to transmit the additional view video in the broadband network.

For example, the second processing unit 630 may convert the format of the encoded additional view video to an MPEG-2 format or an MPEG-4 format.

When the format of the additional view video is converted to an MPEG-2 TS, the additional view video of the SCHCBB may be signaled based on a stream_type value of “0x23” as defined in reference [9]. Referencing information of the additional view video may be signaled based on a stream_type value of “0x05” defined in reference [9].

In operation 770, the second transmitter 640 may transmit the encoded additional view video to the receiver via the second network.

According to an embodiment, the second transmitter 640 may transmit an additional view video stream to the receiver via the second network. To transmit the additional view video stream, a broadband network may be used as the second network. When the second transmitter 640 transmits the additional view video stream, the 3D video may be provided to the receiver in real time. For example, when the second transmitter 640 transmits an additional view video stream, a base view video and an additional view video may be transmitted to the receiver in real time. Thus, a 3D video may be provided as a real-time broadcast.

Additionally, according to an embodiment, the second transmitter 640 may transmit an additional view video file to the receiver via the second network. To transmit the additional view video file, a broadband network may be used as the second network. When the second transmitter 640 transmits an additional view video file, a 3D video may be provided to the receiver in non-real time.

In an example, the second transmitter 640 may transmit whole data of an additional view video to the receiver, before data of a base view video is transmitted to the receiver. In this example, a 3D video may be provided in non-real time.

In another example, the second transmitter 640 may transmit partial data of an additional view video to the receiver, before data of a base view video is transmitted to the receiver. When the base view video is transmitted to the receiver, the second transmitter 640 may transmit remaining data of the additional view video to the receiver. In this example, a 3D video may be provided in non-real time.

Through operations 740 and 770, the broadcast apparatus 600 may transmit the base view video and the additional view video to the receiver and accordingly, the 3D video may be provided to the receiver. The receiver may generate a 3D video based on the received base view video and the received additional view video.

When the format of the encoded additional view video is converted, the second transmitter 640 may transmit the additional view video with the converted format to the receiver.

The description of FIGS. 1 through 6 is also applicable to one or more alternate and/or additional embodiments, and accordingly will not be repeated here.

FIG. 8 is a flowchart illustrating operation 740 of FIG. 7.

Operation 740 may include operations 810 and 820.

In operation 810, the first transmitter 620 may transport the multiplexed base view video.

In operation 820, the first transmitter 620 may modulate the transported base view video.

The first transmitter 620 may transmit the modulated base view video to the receiver. For example, the first transmitter 620 may transmit a TS of the modulated base view video to the receiver.

The description of FIGS. 1 through 7 is also applicable to one or more alternate and/or additional embodiments, and accordingly will not be repeated here.

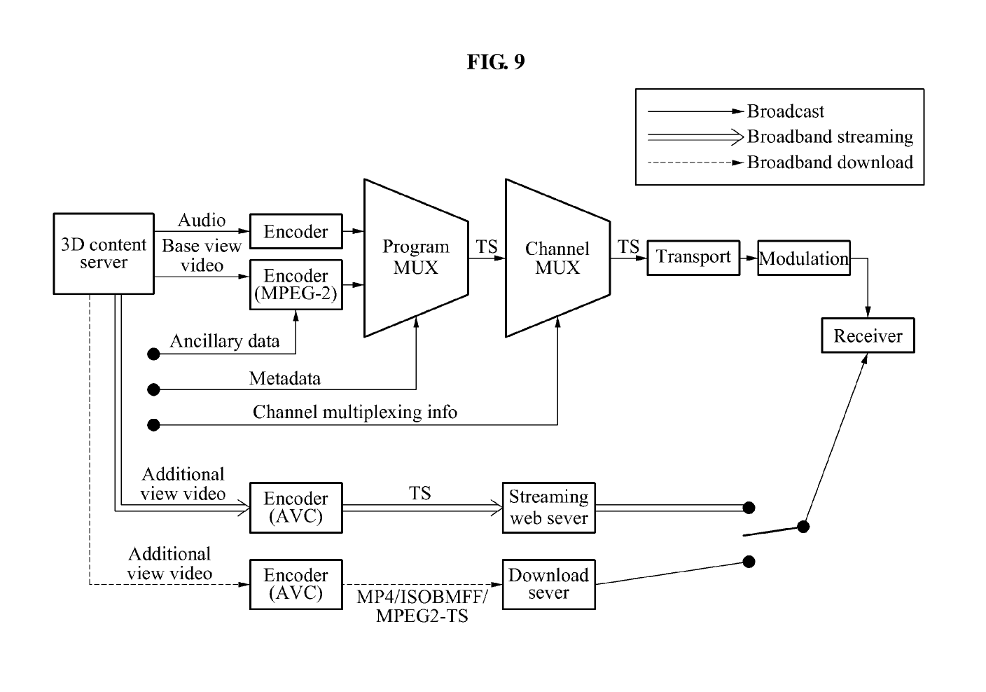

FIG. 9 illustrates a system for providing a 3D video according to an embodiment.

The system of FIG. 9 may provide the first scenario 200 to the third scenario 400 that are described above.

A 3D content server of FIG. 9 may correspond to the storage unit 650 of FIG. 6.

The first processing unit 610 of FIG. 6 may include an encoder used to encode audio, an encoder used to encode a base view video, a program MUX, and a channel MUX.

The first transmitter 620 of FIG. 6 may transport and modulate a TS generated by the first processing unit 610. The first transmitter 620 may transmit the modulated TS to a receiver.

The second processing unit 630 of FIG. 6 may include at least one of an encoder (for example, advanced video coding(AVC)) used for a streaming service and an encoder (for example, AVC) used for a download service.

The second transmitter 640 of FIG. 6 may include at least one of a streaming web server and a download server.

In an SCHCBB streaming scheme, that is, the first scenario 200, the second processing unit 630 may encode an additional view video using the encoder (for example, AVC), and the second transmitter 640 may transmit an additional view video stream to the receiver using the streaming web server.

In an SCHCBB download scheme, that is, the second scenario 300 and the third scenario 400, the second processing unit 630 may encode the additional view video using the encoder (AVC), and the second transmitter 640 may transmit an additional view video file to the receiver using the download server.

The description of FIGS. 1 through 8 is also applicable to one or more alternate and/or additional embodiments, and accordingly will not be repeated here.

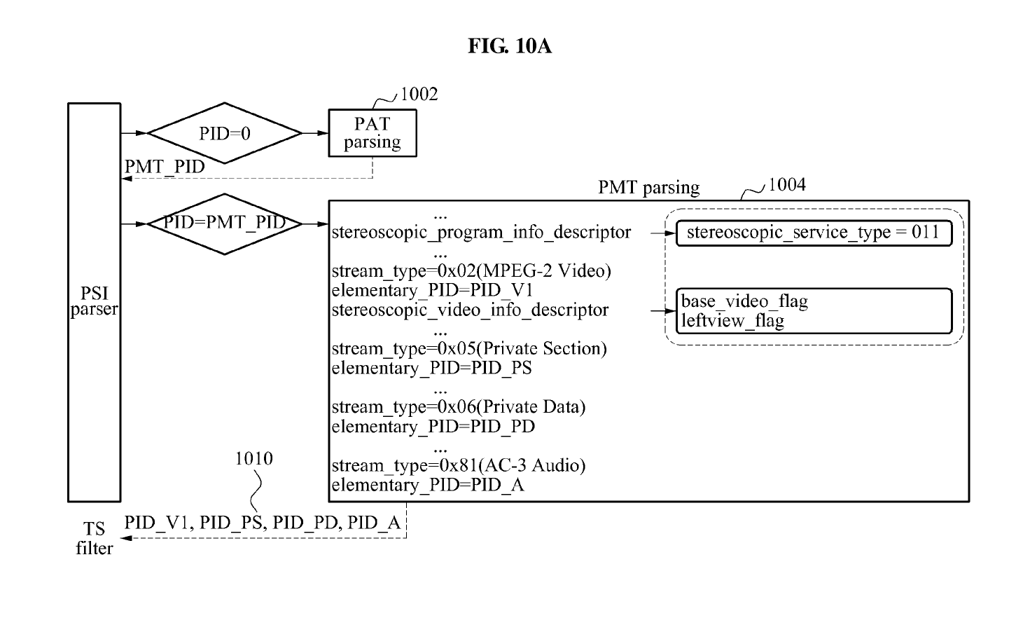

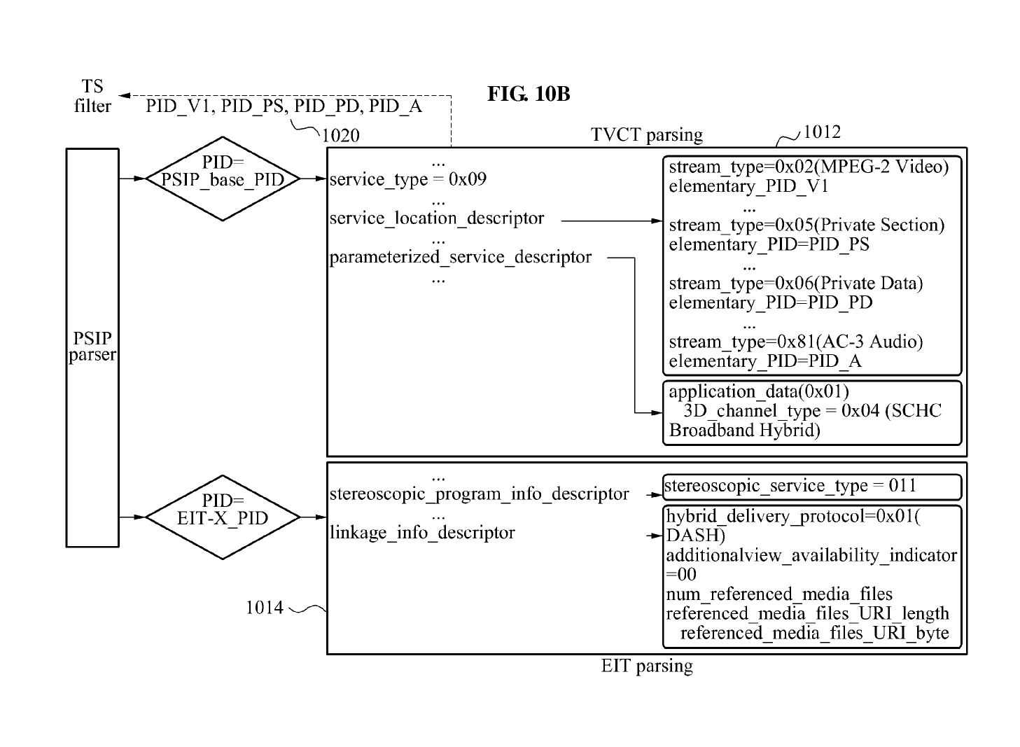

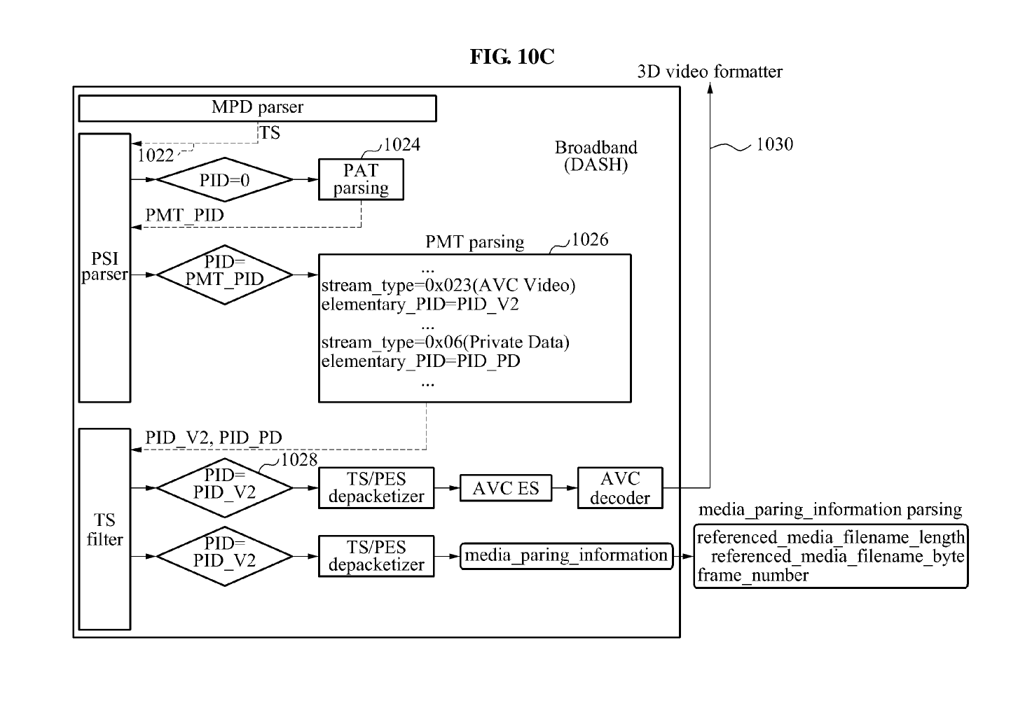

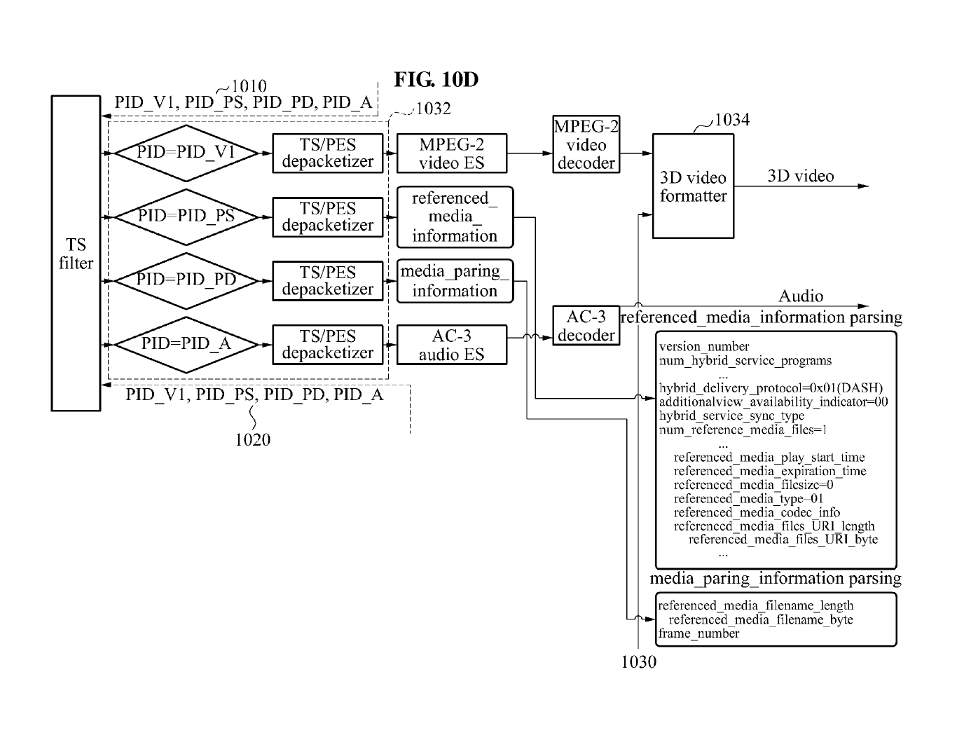

FIGS. 10A through 10D illustrate a method by which a receiver outputs a 3D video when an additional view video is received through a DASH.

Operations 1002 to 1034 may be performed by a receiver to generate a 3D video based on the base view video and the additional view video provided by the first scenario 200 of FIG. 2.

In operation 1002, the receiver may acquire a PAT using a PSI parser. The receiver may acquire PMT_PID by parsing the PAT.

In operation 1004, the receiver may acquire a table with PID=PMT_PID, using the PSI parser. The receiver may acquire an SCHCBB scheme provided by stereoscopic_program_info_descriptor( ) and stereoscopic_video_info_descriptor( ), by parsing a PMT. Additionally, by parsing the PMT, the receiver may acquire PIDs 1010 of tables carrying frame synchronization information, for example, 0x05—referenced_media_information( ) and 0x06—media_pairing_information( ).

Referring to FIG. 10B, the receiver may acquire a TVCT and an EIT using a PSIP parser.

In operation 1012, the receiver may parse the TVCT, so that a virtual channel that provides an SCHCBB may be identified by service_type. The receiver may acquire terrestrial_virtual_channel_table_section( ) by parsing the TVCT. The terrestrial_virtual_channel_table_section( ) may provide service_location_descriptor and parameterized_service_descriptor.

PIDs 1020 may be acquired from the service_location_descriptor.

In operation 1014, the receiver may acquire stereoscopic_program_info_descriptor and linkage_info_descriptor by parsing the EIT. The linkage_info_descriptor may provide information on referenced media files. For example, when an additional view video is transmitted using a DASH, a value of hybrid_delivery_protocol may be “0x01” indicating the DASH.

Operations 1022 to 1028 may be performed on an additional view video.

Referring to FIG. 10C, in operation 1022, the receiver may parse an MPD using an MPD parser. The receiver may request an MPD having an MPEG-TS carrying the PAT and PMT, based on information provided by the linkage_info_descriptor.

In operations 1024 and 1026, the receiver may parse the PAT and PMT, to acquire information on the additional view video.

In operation 1028, the receiver may request a TS having PID_V2 and a TS having a PID of “0x06,” to acquire media_pairing_information.

The additional view video may be decoded by an AVC decoder.

In operation 1030, the receiver may provide the decoded additional view video to a 3D video formatter.

Referring to FIG. 10D, the receiver may receive the PIDs 1010 and 1020.

In operation 1032, the receiver may process each of the PIDs 1010 and 1020 using a TS filter. The receiver may filter a TS with PID=PID_V1 for a base view video, PID=PID_PS for referenced media information, PID=PID_PD for media pairing information, and PID=PID-A for AC-3 audio information.

In operation 1034, the receiver may generate a 3D video based on the base view video decoded by an MPEG-2 video decoder, and the decoded additional view video, using the 3D video formatter.

The description of FIGS. 1 through 9 is also applicable to one or more alternate and/or additional embodiments, and accordingly will not be repeated here.

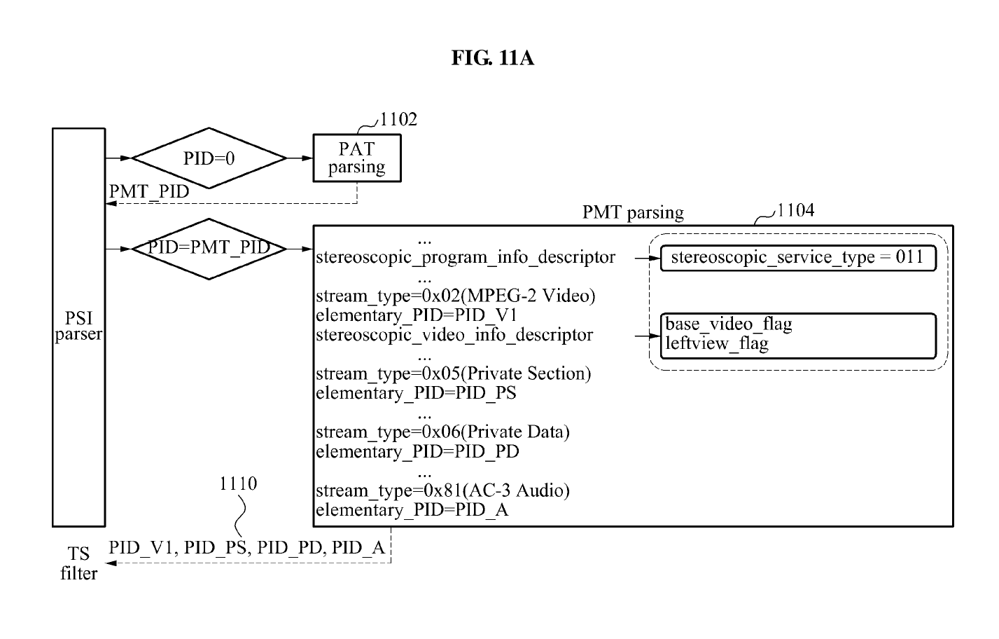

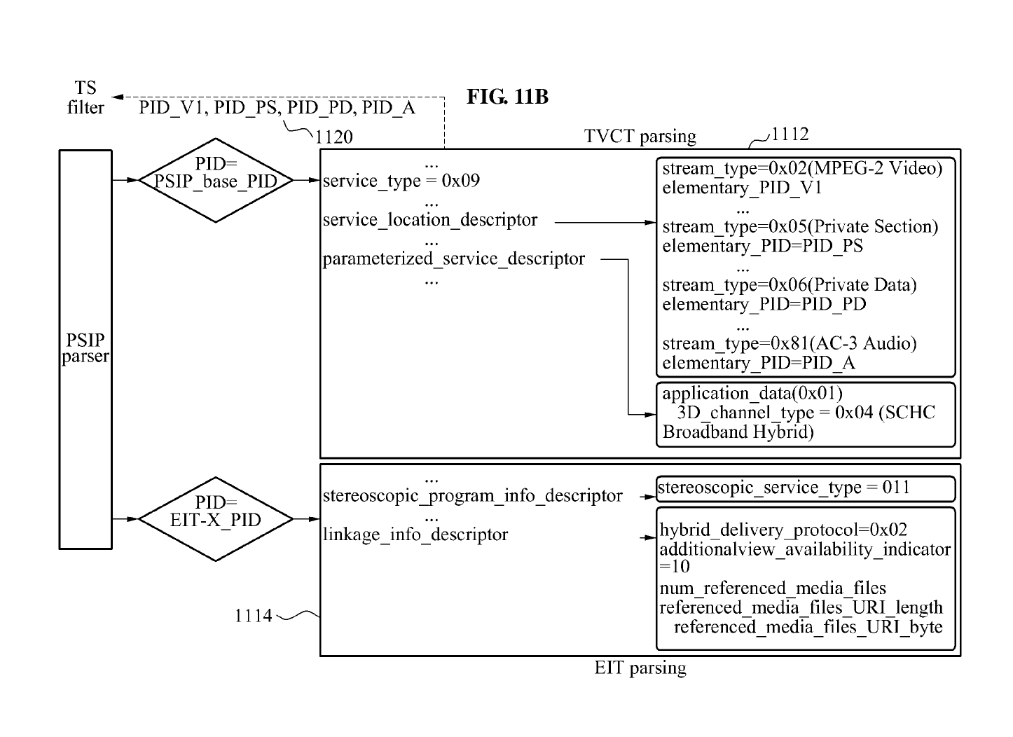

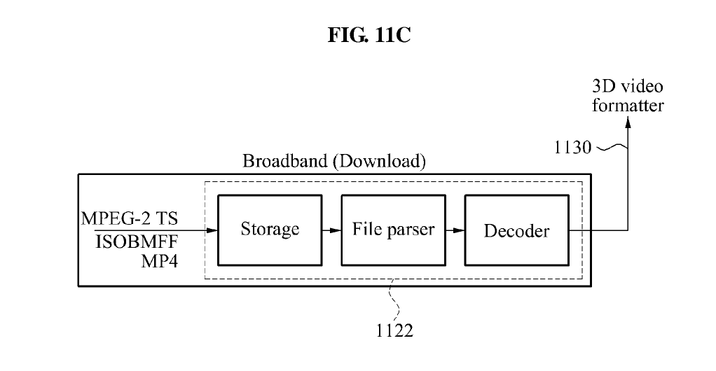

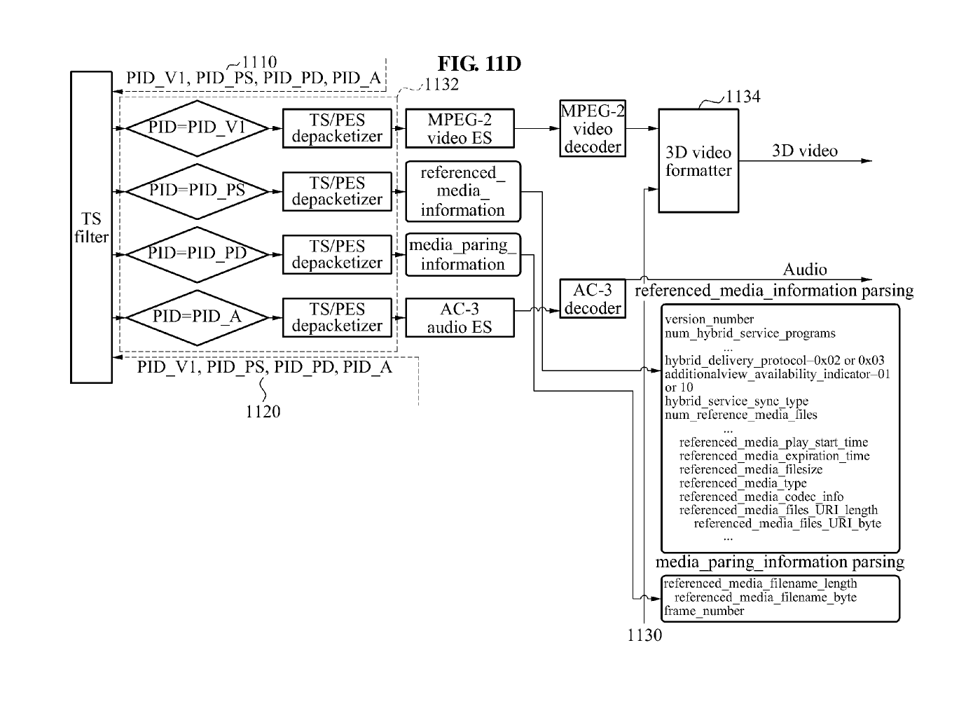

FIGS. 11A through 11D illustrate a method by which a receiver outputs a 3D video when an additional view video is received through download.

Operations 1102 through 1134 may be performed by the receiver to generate a 3D video, based on the base view video and the additional view video provided by the second scenario 300 or the third scenario 400.

Operations 1102 and 1104 of FIG. 11A may correspond to operation 1002 and 1004 of FIG. 10A, respectively, and accordingly description of operation 1102 and 1104 may be replaced by the description of operation 1002 and 1004.

Operation 1112 may correspond to operation 1012 of FIG. 10B and accordingly, description of operation 1112 may be replaced by the description of operation 1012.

In operation 1114, the receiver may acquire stereoscopic_program_info_descriptor and linkage_info_descriptor, by parsing an EIT. The linkage_info_descriptor may provide information on referenced media files. For example, when an additional view video is transmitted using a download scheme, hybrid_delivery_protocol may have a value of “0x02” or “0x03” indicating the download scheme. In the second scenario 300, the hybrid_delivery_protocol may have the value of “0x02,” and in the third scenario 400, the hybrid_delivery_protocol may have the value of “0x03.”

Operation 1122 of FIG. 11C may be performed on an additional view video.

In operation 1122, the receiver may decode the additional view video. The decoded additional view video may be transmitted to a 3D video formatter.

Referring to FIG. 11D, the receiver may receive PIDs 1110 and 1120.

Operations 1132 and 1134 of FIG. 11D may correspond to operations 1032 and 1034 of FIG. 10D, respectively, and accordingly description of operations 1132 and 1134 may be replaced by the description of operations 1032 and 1034.

The description of FIGS. 1 through 10D is also applicable to one or more alternate and/or additional embodiments, and accordingly will not be repeated here.

FIG. 12 is a flowchart illustrating another method of providing a 3D video according to an embodiment.

Operations 1210 to 1270 of FIG. 12 may be performed based on the fourth scenario 500. In other words, operations 1210 to 1270 may provide an SCHCNRT.

Operation 1210 may correspond to operation 710 of FIG. 7 and accordingly, description of operation 1210 may be replaced by the description of operation 710.

Operation 1220 may correspond to operation 720 of FIG. 7 and accordingly, description of operation 1220 may be replaced by the description of operation 720.

In an example, in the SCHCNRT, a base view video may have a stream_type value of “0x02” in a PSI, and an additional view video may have a stream_type value of “0x23.” The base view video and the additional view video may be signaled based on the stream_type value of “0x02” and the stream_type value of “0x23,” respectively.

In another example, in the SCHCNRT, an additional view video may be signaled based on a stream_type value of “0x0D” specified in DSMCC-Addressable Section of reference [16].

In still another example, in the SCHCNRT, video frame synchronization information media_pairing_information( ) may be signaled based on a stream_type value of “0x06” specified in reference [9].

Operation 1230 may correspond to operation 730 of FIG. 7 and accordingly, description of operation 1230 may be replaced by the description of operation 730.

In operation 1230, a value of hybrid_delivery_protocol of linkage_info_descriptor may be set to “0x00” for the SCHCNRT.

For the SCHCNRT, a value of additionalview_availability_indicator of the linkage_info_descriptor may be set to “10.”

Signaling at 2D/3D boundaries may comply with section 4.6.3 in A/104 Part2 of reference [15].

In operation 1240, the first transmitter 620 may transmit the multiplexed base view video to the receiver via the first network in real time.

Operation 1240 may correspond to operation 740 of FIG. 7 and accordingly, description of operation 1240 may be replaced by the description of operation 740.

Operation 1250 may correspond to operation 750 of FIG. 7 and accordingly, description of operation 1250 may be replaced by the description of operation 750.

In operation 1260, the second processing unit 630 may convert a format of the encoded additional view video.

The second processing unit 630 may convert the format of the encoded additional view video to an MPEG-TS that is a file format specified in reference [16]. For example, the second processing unit 630 may convert the format of the encoded additional view video to an MPEG-2 format or an MPEG-4 format.

Operation 1260 may correspond to operation 760 of FIG. 7 and accordingly, description of operation 1260 may be replaced by the description of operation 760.

In operation 1265, the second processing unit 630 may multiplex the additional view video. The multiplexing may be, for example, channel multiplexing.

The second processing unit 630 may multiplex the additional view video, in compliance with ATSC A/103:102 of reference [16].

In operation 1265, the second processing unit 630 may signal the additional view video to transmit the multiplexed additional view video to the receiver. During the signaling, a Service Signaling Channel (SSC) may be used to transmit a Service Map Table (SMT) and a Non-Real-Time Information Table (NRT-IT).

The SMT may provide information on a service of providing a 3D video.

The NRT-IT may provide content item information to form the service.

The SSC, the SMT and the NRT-IT may comply with ATSC A/103:2012 of reference [16].

The additional view video may be multiplexed to use a terrestrial network.

In operation 1270, the second transmitter 640 may transmit the multiplexed additional view video to the receiver via the second network in non-real time. The second network may be, for example, an ATSC NRT network.

The description of FIGS. 1 through 11D is also applicable to one or more alternate and/or additional embodiments, and accordingly will not be repeated here.

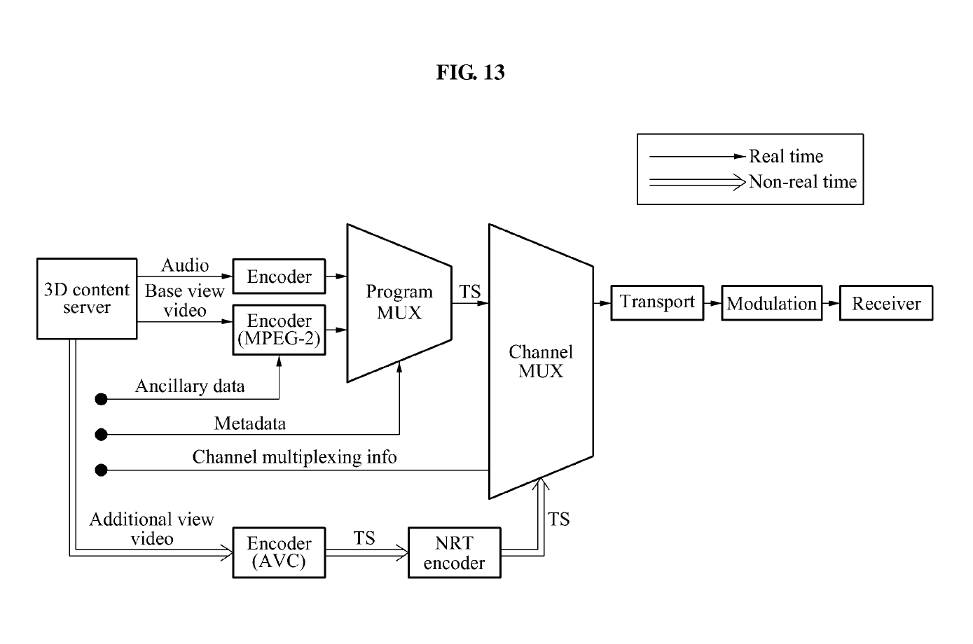

FIG. 13 illustrates another system for providing a 3D video according to an embodiment.

A 3D content server of FIG. 13 may correspond to the storage unit 650 of FIG. 6.

The first processing unit 610 of FIG. 6 may include an encoder used to encode audio, an encoder used to encode a base view video, a program MUX, and a channel MUX.

The first transmitter 620 of FIG. 6 may transport and modulate a TS generated by the first processing unit 610. The first transmitter 620 may transmit the modulated TS to a receiver.

The second processing unit 630 of FIG. 6 may include an encoder(AVC) and an NRT encoder.

According to an embodiment, the second processing unit 630 may further include a channel MUX.

The description of FIGS. 1 through 12 is also applicable to one or more alternate and/or additional embodiments, and accordingly will not be repeated here.

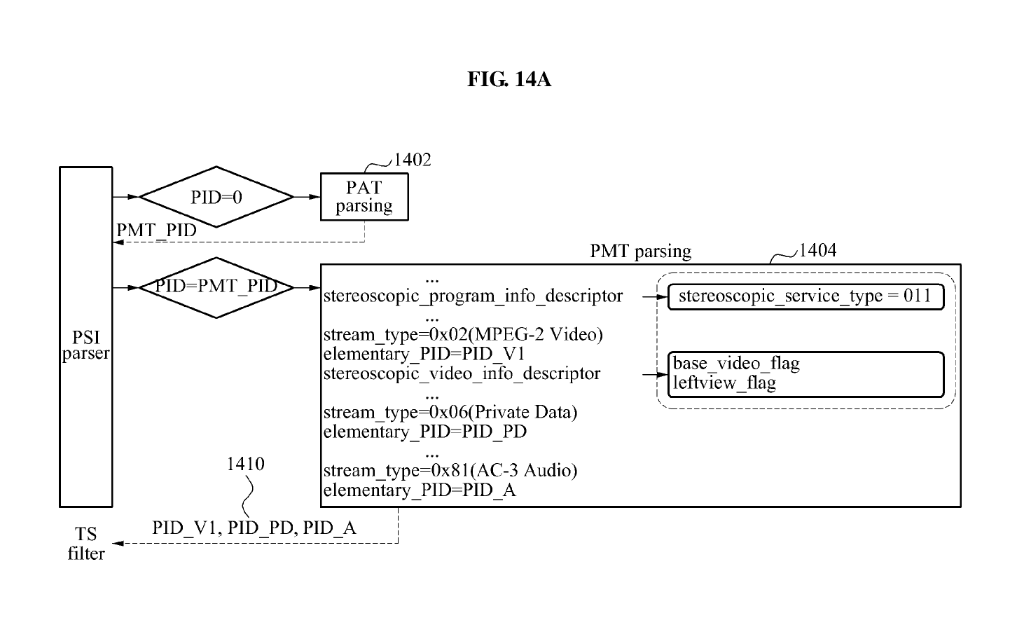

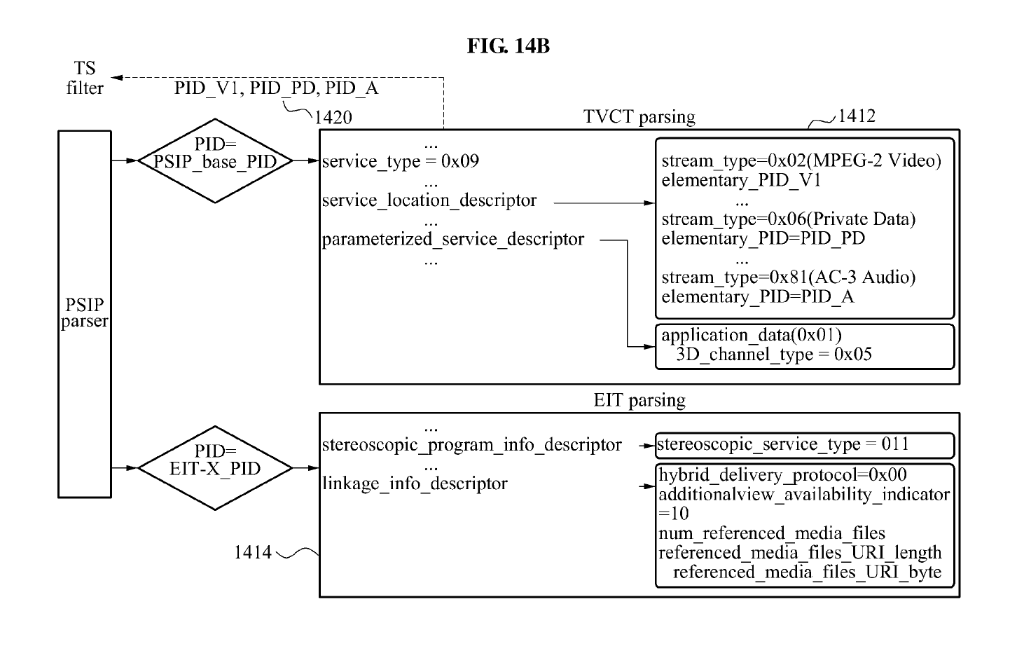

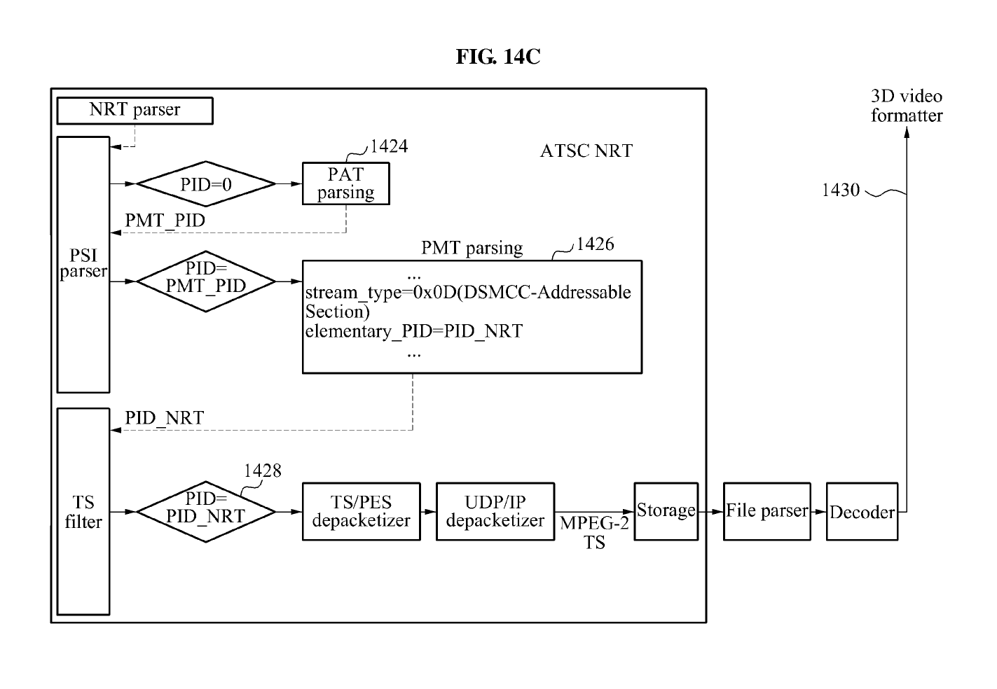

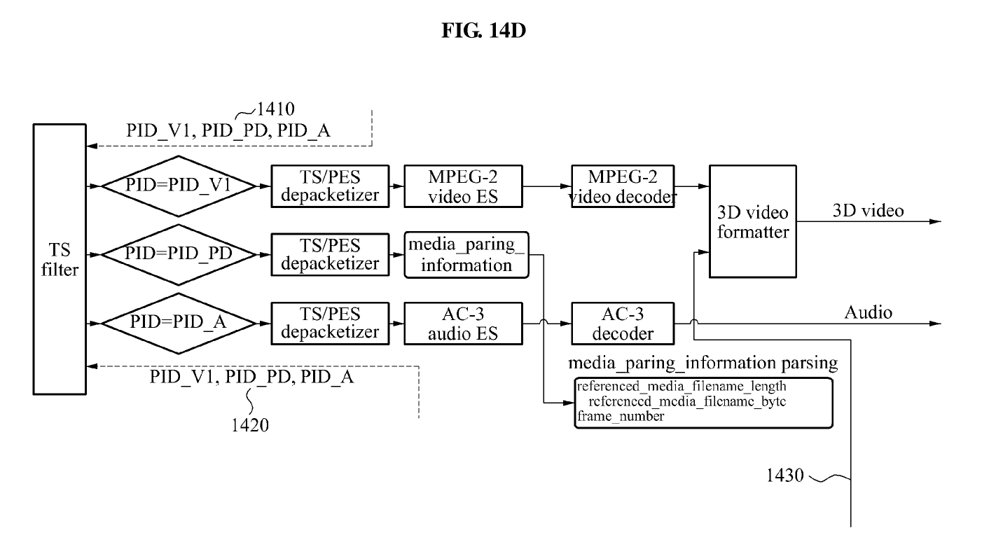

FIGS. 14A through 14D illustrate a method by which a receiver outputs a 3D video when an additional view video is received through an ATSC NRT network.

Operations 1402 to 1434 may be performed by a receiver to generate a 3D video based on the base view video and the additional view video provided by the fourth scenario 500 of FIG. 5.

Operation 1402 and 1404 of FIG. 14A may correspond to operations 1002 and 1004 of FIG. 10A, respectively, and accordingly description of operation 1402 and 1404 may be replaced by the description of operation 1002 and 1004.

Operation 1412 of FIG. 14B may correspond to operation 1012 of FIG. 10B and accordingly, description of operation 1412 may be replaced by the description of operation 1012.

In operation 1412, in service_location_descriptor for an SCHCNRT, a field for PID_PS may not be designated, unlike an SCHCBB.

In the SCHCNRT, 3D_channel_type may have a value of “0x05.”

In the SCHCNRT, hybrid_delivery_protocol may have a value of “0x00.”

In the SCHCNRT, additionalview_availability_indicator may have a value of “10.”

Operations 1424 to 1428 of FIG. 14C may be performed on an additional view video.

In operation 1424, the receiver may parse a PAT acquired using a PSI parser. By parsing the PAT, PMT_PID may be acquired.

In operation 1426, the receiver may parse a PMT. By parsing the PMT, an SMT and an NRT-IT may be acquired.

The receiver may download a file of the additional view video, based on the SMT and the NRT-IT, through the ATSC NRT network.

In operation 1428, the receiver may download and extract a TS file of the additional view video.

The receiver may decode the extracted TS file of the additional view video.

In operation 1430, the receiver may transmit the decoded TS file of the additional view video to a 3D video formatter.

Referring to FIG. 14D, the receiver may receive PIDs 1410 and 1420.

The description of FIGS. 1 through 13 is also applicable to one or more alternate and/or additional embodiments, and accordingly will not be repeated here.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A broadcasting apparatus for providing a three-dimensional (3D) video through heterogeneous networks, the broadcasting apparatus comprising:
a first processing unit to encode a base view video of the 3D video, and to multiplex the encoded base view video to a Transport Stream (TS);
a first transmitter to transmit the multiplexed base view video to a receiver via a first network;
a second processing unit to encode an additional view video of the 3D video; and
a second transmitter to transmit the encoded additional view video to the receiver via a second network,
wherein the first network is a terrestrial network, and
wherein the 3D video is provided based on the base view video and the additional view video.

2. The broadcasting apparatus of claim 1, wherein the first network is an Advanced Television System Committee (ATSC) terrestrial network.

3. The broadcasting apparatus of claim 1, wherein the second network is a broadband network.

4. The broadcasting apparatus of claim 1, wherein the base view video and the additional view video are transmitted in real time to the receiver, so that the 3D video is provided as a real-time broadcast.

5. The broadcasting apparatus of claim 1, wherein the second transmitter transmits whole data of the additional view video to the receiver, before data of the base view video is transmitted to the receiver, and
wherein the 3D video is provided in non-real time.

6. The broadcasting apparatus of claim 1, wherein the second transmitter transmits partial data of the additional view video to the receiver, before data of the base view video is transmitted to the receiver,
when the data of the base view video is transmitted to the receiver, the second transmitter transmits remaining data of the additional view video to the receiver, and
wherein the 3D video is provided in non-real time.

7. The broadcasting apparatus of claim 1, wherein the multiplexed base view video comprises a first Presentation Time Stamp (PTS) indicating a playback time of the base view video,
wherein the encoded additional view video comprises a second PTS indicating a playback time of the additional view video, and
wherein the first PTS and the second PTS are used to synchronize the base view video and the additional view video.

8. The broadcasting apparatus of claim 1, wherein the first processing unit multiplexes the encoded base view video to the TS based on the encoded base view video and metadata associated with the 3D video.

9. The broadcasting apparatus of claim 8, wherein the metadata comprises pairing information used to synchronize the base view video and the additional view video.

10. The broadcasting apparatus of claim 9, wherein the pairing information comprises a Uniform Resource Identifier (URI) used to provide the additional view video, and
wherein the additional view video is transmitted to the receiver through the URI.

11. The broadcasting apparatus of claim 1, wherein the second processing unit converts a format of the encoded additional view video to a Moving Picture Experts Group (MPEG)-2 format or an MPEG-4 format, and
wherein the second transmitter transmits the additional view video with the converted format to the receiver.

12. A broadcasting apparatus for providing a three-dimensional (3D) video, the broadcasting apparatus comprising:
a first processing unit to encode a base view video of the 3D video, and to multiplex the encoded base view video to a Transport Stream (TS);
a first transmitter to transmit the multiplexed base view video to a receiver via a first network in real time;
a second processing unit to encode an additional view video of the 3D video, and to multiplex the encoded additional view video; and
a second transmitter to transmit the multiplexed additional view video to the receiver via a second network in non-real time,
wherein the first network is a terrestrial network, and
wherein the 3D video is provided based on the base view video and the additional view video.

13. The broadcasting apparatus of claim 12, wherein the first network is an Advanced Television System Committee (ATSC) terrestrial network, and
wherein the second network is an Advanced Television System Committee Non Real Time (ATSC NRT) network.

14. The broadcasting apparatus of claim 12, wherein the multiplexed base view video comprises a first Presentation Time Stamp (PTS) indicating a playback time of the base view video,
wherein the multiplexed additional view video comprises a second PTS indicating a playback time of the additional view video, and
wherein the first PTS and the second PTS are used to synchronize the base view video and the additional view video.

15. The broadcasting apparatus of claim 14, wherein playback information of the 3D video is provided based on the first PTS.

16. The broadcasting apparatus of claim 12, wherein the first processing unit multiplexes the encoded base view video to the TS based on the encoded base view video and metadata associated with the 3D video.

17. The broadcasting apparatus of claim 12, wherein the second processing unit converts a format of the encoded additional view video to a Moving Picture Experts Group (MPEG)-2 format or an MPEG-4 format, and multiplexes the additional view video with the converted format.

18. The broadcasting apparatus of claim 12, wherein the second processing unit signals the additional view video to transmit the multiplexed additional view video to the receiver,
wherein during the signaling, a Service Signaling Channel (SSC) is used to transmit a Service Map Table (SMT) and a Non-Real-Time Information Table (NRT-IT),
wherein the SMT provides information on a service of providing the 3D video, and
wherein the NRT-IT provides content item information to form the service.

19. A method of providing a three-dimensional (3D) video through heterogeneous networks, the method comprising:
encoding a base view video of the 3D video;
multiplexing the encoded base view video to a Transport Stream (TS);
transmitting the multiplexed base view video to a receiver via a first network, the first network being a terrestrial network;
encoding an additional view video of the 3D video; and
transmitting the encoded additional view video to the receiver via a second network,
wherein the 3D video is provided based on the base view video and the additional view video.

20. A method of providing a three-dimensional (3D) video, the method comprising:
encoding a base view video of the 3D video;
multiplexing the encoded base view video to a Transport Stream (TS);
transmitting the multiplexed base view video to a receiver via a first network in real time, the first network being a terrestrial network;
encoding an additional view video of the 3D video;
multiplexing the encoded additional view video; and
transmitting the multiplexed additional view video to the receiver via a second network in non-real time,
wherein the 3D video is provided based on the multiplexed base view video and the multiplexed additional view video.
